(19) United States
(12) Patent Application Publication
(10) Pub. No.: US 2008/0181441 A1
(43) Pub. Date: Jul. 31, 2008

(54) ADJUSTABLE LENGTH EAR INSERT

(76) Inventor: Richard C. Smith, Costa Mesa, CA (US)

Correspondence Address: MACPHERSON KWOK CHEN & HEID LLP, 2033 GATEWAY PLACE, SUITE 400, SAN JOSE, CA, 95110, US

(21) Appl. No.: 11/872,324

(22) Filed: Oct. 15, 2007

Related U.S. Application Data
(63) Continuation-in-part of application No. 11/411,314, filed on Apr. 26, 2006.
Application No. 11/411,314 is a continuation-in-part of application No. 11/247,105, filed on Oct. 11, 2005.

(51) Int. Cl. H04R 25/00

(52) U.S. Cl. 381/328; 181/135

(57) ABSTRACT

An earpiece assembly for use by police, fire and military personal is disclosed. The earpiece assembly can have an earpiece configured to fit substantially within the conchae of an ear and an ear insert adjustable attached to the earpiece. The ear insert extends into the ear canal and can bring sound from a two-way radio close to the eardrum so as to facilitate better hearing. The distance that the stem extends into an ear canal can be varied so as to enhance sound delivery to the eardrum. An earplug embodiment is also disclosed.

### RELATED APPLICATIONS

This patent application is a continuation-in-part (CIP) patent application of U.S. Ser. No. 11/411,314 filed Apr. 26, 2006, and entitled EARPIECE WITH EXTENSION (docket no. M-15744-1P US) which is a continuation-in-part (CIP) patent application of U.S. Ser. No. 11/247,105 filed on Oct. 11, 2005, and entitled EARPIECE WITH FLANGED EXTENSION, the entire contents of both of which are hereby expressly incorporated by reference.

### TECHNICAL FIELD

The present invention relates generally to audiology. The present invention relates more particularly to earpieces such as those worn by police officers, firefighters and soldiers for communications (such as with a two-way radio) and for hearing protection, wherein the earpiece has an ear insert that extends into the ear canal by a distance that can be adjusted.

### BACKGROUND

Law enforcement, firefighters, and military personnel frequently wear earpieces that fit into the conchae bowl of the ear so as to facilitate listening to two-way radios and the like. Such earpieces are different from earplugs in that they are intended to allow some sound (the sound from the two-way radio) to enter the ear. The earpieces can also be configured to allow ambient sound to enter the ear. The earpieces are attached via acoustic tubing to a small speaker. Communications received by the two-way radio are reproduced by the speaker. Sound then travels through the acoustic tubing from the speaker to the user's ear, where the end of the acoustic tubing is attached to the earpiece so that the sound can be heard.

The sound output port or opening of such contemporary earpieces is generally further away from the eardrum than is sometimes desirable. In any event, the position of the sound output port with respect to the eardrum is fixed for contemporary earpieces.

Positioning of the sound output port too far from the eardrum necessitates that the volume of the speaker be increased more than would be required if the sound output port were closer to the eardrum. When the volume of the speaker is increased, the likelihood of another person hearing a communication is undesirably increased. In some situations, such as covert operations, it is undesirable for another person to hear a communication. Indeed, allowing another person to hear a communication can jeopardize the life of a user.

Hearing protection for use in noisy environments is well known. Hearing protection is commonly used in such noisy environments as manufacturing facilities, warehouses, construction sites, shooting ranges, battlefields, and airports. Typically, any time that loud machinery is being operated, guns are being fired, or any other source of excessive noise is present, hearing protection is desirable so as to reduce discomfort and so as to conserve hearing. Contemporary hearing protection typically comprises either a noise reducing headset or earplugs.

Although headsets are generally effective in reducing noise exposure, they suffer from deficiencies that tend to make them unsuitable for some applications. Headsets are bulky. They cannot be worn in environments where they may get in the way, and they cannot be worn under helmets.

Additionally, headsets tend to become uncomfortable after being worn for an extended period of time. Because of this, wearers may discontinue their use while they remain within a noisy environment. Wearers may alternatively stretch the earpieces (cups) of the headset apart from one another, so that they do not apply as much pressure to the sides of the head. However, when the pressure is reduced in this manner, then the earpieces may not seal properly and thus may permit the introduction of excessive sound. In either instance, noise exposure is undesirably increased.

Earplugs can also be effective. However, they can similarly become uncomfortable when worn for extended periods of time. Further, earplugs tend to work loose during usage, thus reducing their effectiveness. They may even fall out.

The effectiveness and comfort of earpieces for both communications and hearing protection is determined, at least in part, by the fit thereof. Therefore, it is desirable to improve the fit of earpieces.

### BRIEF SUMMARY

An earpiece assembly for use by police, fire and military personnel is disclosed. Both communications and hearing protection embodiments of the earpiece assembly are disclosed. Combined embodiments that both facilitate communications and provide hearing protection are also disclosed.

In both communications, hearing protection, and combined embodiments, enhanced fit, comfort, and effectiveness are provided. The earpiece assembly can comprise an earpiece and an ear insert attached to the earpiece. Flanges can be formed upon a stem of the ear insert. The position of the ear insert within the ear canal can be varied so as to enhance fit, comfort, and effectiveness.

In communications embodiments, the position of the distal end of an ear insert (as well as of the flanges thereof) can be adjusted so as to enhance the fit of the earpiece assembly and so as to enhance sound delivery to the eardrum. The distal end of the ear insert can be moved closer to or farther away from the eardrum. In this manner, a desired intensity of sound can be provided to the eardrum for a given volume of a speaker of an audio device such as a two-way radio. Enhancing sound delivery to the eardrum, as well as enhancing fit, enhances the effectiveness of earpiece assemblies used for communications.

More particularly, an ear insert can comprise a stem configured to extend into an ear canal, wherein the stem is configured to attach to an earpiece such that a length of the stem of the ear insert within the ear canal is variable. Varying the length of the ear insert allows the distal end or sound port thereof to be positioned as desired. Varying the length of the ear insert allows flanges formed upon the stem to be positioned as desired.

Various different means can be used to attach the ear insert to the earpiece in a manner that facilitates adjustment of the length of the stem of the ear insert within the ear canal. For example, the ear insert can be slidably or frictionally attachable to the earpiece such that the ear insert can be slid within the earpiece to obtain the desire length of the ear insert that extends inwardly (toward the eardrum) away from the earpiece. Friction between the ear insert and the earpiece can inhibit further (undesirable) movement of the ear insert with respect to the earpiece after the length of the earpiece has been set.

A plurality of detents can be formed upon the ear insert so as to engage the earpiece and better inhibit undesirable movement of the ear insert with respect to the earpiece after the length of the ear insert has been set. Such detents can be used in addition to a friction fit or other means for inhibiting undesirable movement of the ear insert with respect to the earpiece.

The ear insert can threadedly engage the earpiece such that turning the ear insert with respect to the earpiece results in varying the length of the ear insert that extends inwardly away from the earpiece. Such threads can be used in addition to a friction fit or other means for inhibiting undesirable movement of the ear insert with respect to the earpiece.

An earpiece assembly can comprise an earpiece that is configured to fit substantially within the conchae of an ear and an ear insert that is configured to fit within the ear canal. The ear insert comprises a stem configured to extend into an ear canal. The stem is attached to the earpiece such that a length of the insert within ear canal is variable.

According to a communications embodiment, the stem of the ear insert can be substantially hollow, e.g., have a bore formed therethrough, so as to facilitate the transmission of sound (such as from a two-way radio) therethrough. A filter or other structure can be formed in the bore so as to modify the sound passing therethrough. This embodiment can also provide a substantial amount of hearing protection.

According to a hearing protection embodiment, the stem of the earpiece can be substantially solid such that the earpiece assembly functions as an earplug and mitigates the transmission of ambient sound to the eardrum. According to a hearing protection embodiment, the stem of the earpiece can have a bore passing substantially therethrough. The bore can be configured so as to facilitate the transmission of desirable sound while mitigating the transmission of undesirable sound. For example, a Hoch's filter can be disposed within the bore to mitigate the transmission of higher intensity sounds while facilitating the transmission of lower intensity sounds.

By facilitating adjustment of the length of the ear insert within the ear canal of a user, the configuration of the earpiece assembly can be optimized so as to provide enhanced sound delivery to the users. In this manner, speech received via a two-way radio, for example, can be more intelligible. Speech can be more intelligible at lower speaker volumes.

By facilitating adjustment of the length of the ear insert within the ear canal of a user, the configuration of the earpiece assembly can be optimized to provide a better and more comfortable fit for either a communications earpiece or a hearing protection earpiece (earplug).

Also, the volume of the two-way radio or other audio device can be decreased because of the enhanced efficiency of sound delivery to the ear drum. Such reduction in the sound volume can increase the length of the batteries' life, thereby enhancing the utility of the audio device.

This invention will be more fully understood in conjunction with the following detailed description taken together with the following drawings.

### BRIEF DESCRIPTION OF THE DRAWINGS

FIG. 1 is a perspective view of an earpiece having a flanged ear insert according to an embodiment of the present invention;

FIG. 2 is a perspective view of the ear insert of FIG. 1, wherein the ear insert is removed from the earpiece;

FIG. 3 is a perspective view of an embodiment of the ear insert of FIG. 2 wherein a plurality of rings are formed upon a portion of the stem of the ear insert to facilitate adjustment of the length thereof that extends into a user's ear canal;

FIG. 4 is a perspective view of another embodiment of the ear insert of FIG. 2 wherein threads are formed upon a portion of the stem of the ear insert to facilitate adjustment of the length thereof that extends into a user's ear canal;

FIG. 5 is a perspective view of another embodiment of the ear insert of FIG. 2, wherein bumps are formed upon a portion of the stem of the ear insert to facilitate adjustment of the length thereof that extends into a user's ear canal and also showing a Hoch's filter inserted into a bore of the ear insert to inhibit loud noises from reaching the eardrum;

FIG. 6 is a side view of the earpiece of FIG. 1, wherein the ear insert is removed therefrom;

FIG. 7 is a bottom view of the earpiece of FIG. 6, showing the opening therein with dashed lines;

FIG. 8 is a perspective view of an earpiece having an ear insert with one flange, according to an embodiment of the present invention;

FIG. 9 is a perspective view of the ear insert of FIG. 8, wherein the ear insert is removed from the earpiece and has bumps formed upon a stem thereof; and

FIG. 10 is a perspective view of the earpiece of FIG. 1 having acoustic tubing attached thereto.

Embodiments of the present invention and their advantages are best understood by referring to the detailed description that follows. It should be appreciated that like reference numerals are used to identify like elements illustrated in one or more of the figures.

### DETAILED DESCRIPTION

An earpiece assembly for use by police, fire and military personnel is disclosed. The earpiece assembly can have an earpiece that is configured to fit substantially within the conchae of an ear and can have an ear insert that is adjustably attached to the earpiece. Thus, the earpiece assembly can be adjusted so as to vary the length of the ear insert within a user's ear canal. The length of the ear insert that extends into the ear canal can be adjusted so as to bring sound from an audio device, such as two-way radio, a music player (an MP3® player or an iPod®) or a cellular telephone, closer to the eardrum of the user so as to provide better hearing.

Bringing the sound closer to the eardrum also allows the audio device to be used at lower volumes. Operation of some audio devices at lower volumes can be advantageous in some situations, such as covert operations. Operation of an audio device at lower volumes can also conserve battery life, which can provide longer use in some situations where longer use is beneficial, such as in the battlefield.

Adjustment of the length of ear insert within the ear canal can also accommodate a wider range of ear canal configurations and thus facilitate better hearing and/or hearing protection. A wider range of ear canal configurations can be accommodated both by positioning the distal end of the ear insert a desired distance from the eardrum and by positioning flanges or other structures of the ear insert at desired positions within the ear canal.

An earplug embodiment is also disclosed. Thus, an embodiment can comprise an earpiece with a flanged ear insert that is suitable for use as hearing protection, is suitable for facilitating listening to a two-way radio or the like, or is suitable for providing a combination of hearing protection and such listening. The present invention may comprise a solid ear insert so as to substantially attenuate ambient sound. Alternatively, the present invention may comprise a hollow or partially hollow ear insert to allow desired ambient sound or sound from a radio to pass therethrough.

More particularly, an ear insert can comprise a stem that is configured to extend into an ear canal. The stem can be configured to attach to an earpiece such that a length of the insert within an ear canal is variable. For hearing protection, the stem can be substantially solid so as to inhibit the transmission of ambient sound therethrough. Alternatively, the stem can have a bore formed substantially therethrough so as to facilitate the transmission of sound therethrough for use with a two-way radio or the like.

The stem of the ear insert can have one or more flanges formed thereon. The flanges can provide an enhanced seal so as to better mitigate the transmission of ambient sound through the ear canal. The position of the flanges within the ear canal can be varied so as to tend to optimize the seal and, consequently, enhance ambient sound attenuation. Ambient sound attenuation tends to be optimized when the size of the flanges is matched to the size of the ear canal at the position of the flanges within the ear canal. The size of the flanges is matched to the size of the ear canal when flanges fit comfortably within the ear canal while adequately sealing the ear canal. The flanges can also enhance the fit of the earpiece assembly so as to allow the earpiece assembly to fit more securely within a user's ear.

Whether used for communications (such as having a hollow stem for sound transmission) or for hearing protection (such as having a solid stem for sound attenuation), the ability to position the stem and/or flanges within the ear canal facilitates better fitting of the earpiece assembly to a particular user's ear anatomy. As those skilled in the art will appreciate, the diameter of the ear canal of an individual can vary substantially at different positions along the length of the ear canal. Thus, the ability to move the ear insert, particularly the flanges thereof, within the ear canal can substantially enhance the fit of the earpiece assembly by better matching the diameter of the flanges to the diameter of the ear canal at the locations where the flanges are disposed.

As discussed in detail below, the stem of the ear insert can be attached to the earpiece in a variety of different ways that facilitate adjustment of the length of the ear insert within the ear canal of a user. For example, the stem of the ear insert can be slidably attachable to the earpiece such that the length of the ear insert that extends inwardly (into the ear canal) from the earpiece can be adjusted by sliding the ear insert within the earpiece.

One or more detents can be formed upon the ear insert and/or the earpiece so as to inhibit undesirable movement of the ear insert with respect to the earpiece once the length of the ear insert has been set. The detents can comprise bumps, rings, or any other desired structures. The detents can inhibit movement of the stem of the ear insert through the earpieces so as to tend to cause the ear insert to remain in place with respect to the earpiece and thereby maintain a desired length adjustment of the ear insert.

Alternatively, friction can maintain a desired length adjustment of the ear insert with or without the use of detents. For example, the outer diameter of the stem of the ear insert can be sized with respect to the diameter of the opening within the earpiece through which the ear insert moves so as to provide the desire amount of friction and thus the desired ability of the ear insert to resist movement with respect to the earpiece.

The ear insert and/or the earpiece can have threads formed thereon such that adjustment of the length of the ear insert extending inwardly away from the earpiece can be adjusted by turning the ear insert with respect to the earpieces. Thus, the ear insert can threadedly engage the earpiece.

One or more flanges can be formed upon the stem of the ear insert. For example, one, two, three, or more flanges can be formed upon the stem of the ear insert. The flanges can help hold the ear insert in place within the ear canal and can inhibit the transmission of ambient sound through the ear canal.

The ear insert can be formed of rubber, such as silicone rubber. Those skilled in the art will appreciate that other resilient, biocompatible materials can also be used. The ear insert can be formed of a resilient material having Shore A durometer of between approximately 35 and approximately 45. For example, the insert can be formed of a resilient material having Shore A durometer of approximately 40.

Various combinations of attenuation and transmission may be provided. For example, a hollow or partially hollow ear insert may be configured so as to substantially attenuate some ambient sound (such as potentially harmful loud noise), while allowing some ambient sound (such as voices) to be heard. Optionally, the ear insert can comprise one or more openings that allow a substantial portion of ambient sound to be heard, while also allowing radio communications to be heard. Optionally, a filter may be used to selectively allow sounds to be heard.

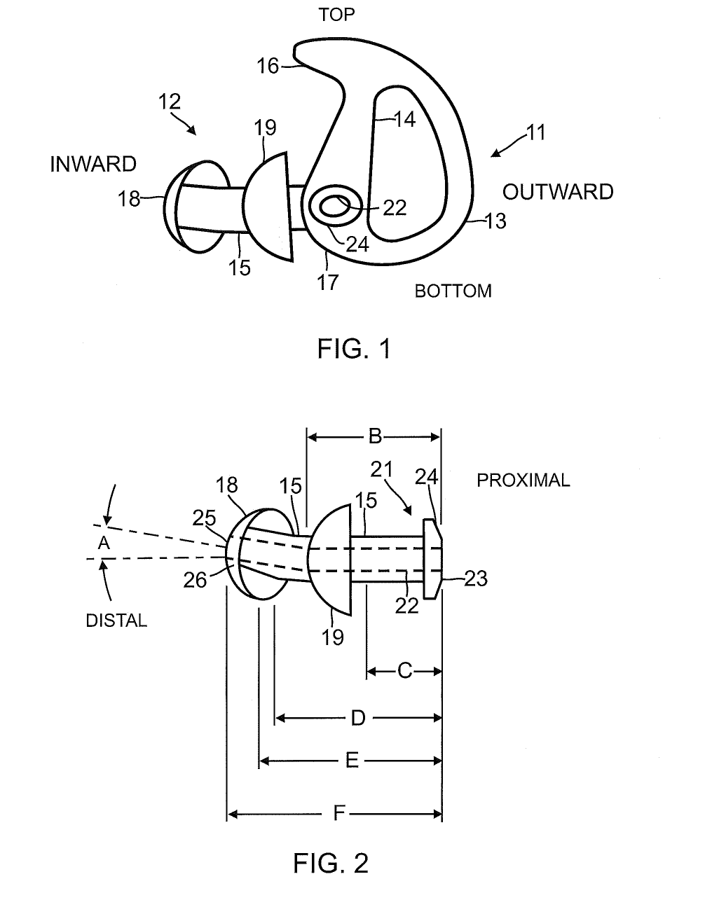

Referring now to FIGS. 1, 2, 6, and 7, one embodiment of the present invention comprises an earpiece 11 to which an ear insert 12 is attached. Earpiece 11 is configured to be disposed in the conchae of the outer ear. Ear insert 12 is configured to be disposed within the ear canal.

Earpiece 11 can comprise a generally arcuate rib 13 that has upper and lower ends. Arcuate rib 13 can be attached to a straight rib 14 at the upper and lower ends of arcuate rib 13. An upper lobe 16 can be formed proximate where arcuate rib 13 and straight rib 14 join at the top of earpiece 11. Similarly, a lower lobe 17 can be formed proximate where arcuate rib 13 and straight rib 14 join at the bottom of earpiece 11. As those skilled in the art will appreciate, other configurations of the earpiece are likewise suitable.

Earpiece 11 is configured to be disposed and held in place within the conchae of a human ear. More particularly, the crus and the antihelix of a wearer's ear cooperate to capture upper lobe 16 and the tragus and antitragus cooperate to capture lower lobe 17. The antihelix and the antitragus cooperate to capture arcuate rib 13. Thus, earpiece 11 is configured to be captured by protrusions of the conchae. In this manner, earpiece 11 is held firmly in place within the conchae and can therefore maintain ear insert 12 in a desired position within the ear canal.

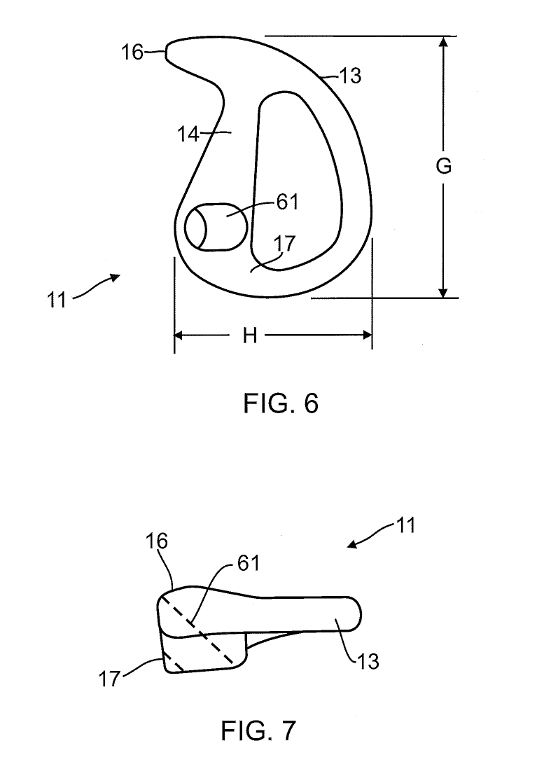

The proximal end of ear insert 12 passes through opening 61 (FIG. 6) of earpiece 11 to facilitate adjustable attachment to earpiece 11. Ear insert 12 can be adjustably attached to earpiece 11 by friction fit, by detents, by threads, or by any other desired means. For example, ear insert 12 can be friction fit to earpiece 11 by sizing a proximal portion 21 (FIG. 2) of ear insert 12 so as fit tightly within an opening 61 of earpiece 11.

The length of the ear insert 12 that extends inwardly away from the earpiece 11 can be adjusted so as to vary the distance between the distal end of the ear insert 12 and the user's eardrum. As those skilled in the art will appreciate, there is wide variation in the configuration of ear canals among individuals. There is also wide variation in the distance to a user's eardrum (the depth of the ear canal) among individuals.

Generally, it is desirable to position the distal end of the ear insert between approximately two and approximately four millimeters from the eardrum. In some instances, it may be desirable to position the distal end of the ear insert closer to the eardrum (such as approximately 1 millimeter therefrom) and in some instances it may be desirable to position the distal end of the ear insert farther from the eardrum.

Once the length adjustment of the ear insert 12 has been performed, then the ear insert 12 can be permanently attached to earpiece 11 such as by adhesive bonding, ultrasonic welding, or by any other desired means. In this manner, inadvertent changes to the adjustment of the ear insert 12 can be mitigated. Alternatively, no such permanent attachment can be performed. In this manner, subsequent re-adjustment of the length of the ear insert can be performed if desired.

Earpiece 11 and ear insert 12 can be formed of a soft, resilient material to enhance comfort during use. Both earpiece 11 and ear insert 12 can be formed of the same material. As discussed above, both the earpiece 11 and the ear insert 12 can be formed of a resilient polymer, such as silicon rubber. Earpiece 11 and ear insert 12 can be formed of a material having a Shore A durometer of between 35 and 45, such as a Shore A durometer of approximately 40.

Earpiece 11 functions as a stop to prevent ear insert 12 from being inserted too far into the ear. This is particularly important since the ear insert 12 can be positioned close to the eardrum.

Earpiece 11 also prevents ear insert 12 from being inadvertently removed or loosened from the ear. That is, earpiece 11 can be held firmly in place by the anatomical structures of the ear.

With particular reference to FIG. 2, according to one embodiment of the present invention ear insert 12 comprises a stem 15 and two flanges, 18 and 19. Ear insert 12 can comprise any desired number of flanges, including no flanges at all, as discussed in further detail below. Stem 15 can either be solid (so as to substantially block sound) or hollow (so as to substantially transmit sound). Stem 15 can also be partially hollow (so as to selectively transmit sound).

Stem 15 can bend such that it angles upwardly to conform to the upward angle of the human ear canal. For example, stem 15 can bend such that it angles upwardly at an angle, Angle A, of approximately 30°. The distance between the proximal end of ear insert 12 and the distal end of outer flange 19, Dimension B, can be approximately 0.545 inch. The distance between the proximal end of ear insert 12 and the point where a filter (such as a Hoch filter) ends, Dimension C, can be approximately 0.304 inch. The distance between the proximal end of ear insert 12 and the bend in stem 15, Dimension D, can be approximately 0.680 inch. The distance between the proximal end of ear insert 12 and a distal end of inner flange 18, Dimension E, can be approximately 0.743 inch. The distance between the proximal end of ear insert 12 and the distal end of inner flange 18, Dimension F, can be approximately 0.870 inch.

The diameter of stem 15 can be approximately 0.189 inch. Stem 15 can optionally have a bore 22 formed therethrough. Bore 22 can have a diameter of approximately 0.094 inch. Outer flange 19 can have a radius of approximately 0.241 inch. Similarly, inner flange 18 can have a radius of approximately 0.193 inch. Thus, the radius of inner flange 18 can be substantially less than the radius of outer flange 19, so as to better accommodate the manner in which the human ear canal becomes narrower as it gets deeper.

The exemplary angle and dimensions discussed above provide a single ear insert that is suitable for use by a large number individuals. Those skilled in the art will appreciate that other dimensions are likewise suitable.

The distal end of bore 22 defines a sound output port 26 (FIGS. 2 and 9). Ear insert 12 is configured such that sound output port 26 is positioned proximate the wearer's eardrum. That is, ear insert 12 can be configured so as to position a distal end 25 thereof proximate the eardrum. In this manner, sound transmitted through bore 22 (such as sound from a two-way radio), is brought close to the eardrum such that the volume of the sound required can be substantially reduced.

The distance between the output port 26 and the eardrum can be varied. For example, the ear insert can position sound output port 26 within one, two, or three millimeters of the eardrum. The ear insert can have a length of approximately ½ inch. The ear insert can have a length of ⅝ inch or more.

A head 23 can be formed upon the proximal end of stem 15 so as to enhance friction with respect to opening 61 of earpiece 11 and/or so as to define a detent that tends to keep ear insert 12 attached to earpiece 11. Bevels 24 can optionally be formed upon head 23 to better facilitate insertion of head 23 through opening 61. The head 24 can be positioned within the opening 61 (FIGS. 6 and 7) of the earpiece or can be pushed entirely therethrough and thus be position on the outward side of earpiece 11.

The ear insert 12 may comprise either a flanged ear insert or a non-flanged ear insert. The flanges generally fill (close off) the ear canal and tend to block ambient sound. Although sometimes it is desirable to block ambient sound, other times, it is desirable for the user to hear ambient sound. The flanges need not be identical, but rather may vary in size, shape, orientation and/or positions of attachment to the stem, for example.

The ear insert can have a bore formed therethrough to facilitate the transmission of sound from a speaker (such as via acoustic tubing connected to the speaker) to the user's eardrum. Alternatively, the ear insert can lack such a bore, so as to define an earplug, such as for attenuating ambient sound. Indeed, the bore and/or openings in the stem and/or flanges can be configured so as to selectively transmit and block desired sounds. Such selectivity can be based upon the frequency and/or intensity of the sound.

A user can wear one earpiece assembly having an ear insert with a bore and one earpiece assembly lacking a bore. The earpiece assembly having an ear insert with a bore can facilitate listening to a two-way radio or the like, while the earpiece assembly having an ear insert without a bore can at least partially block distracting and/or potentially harmful ambient sound.

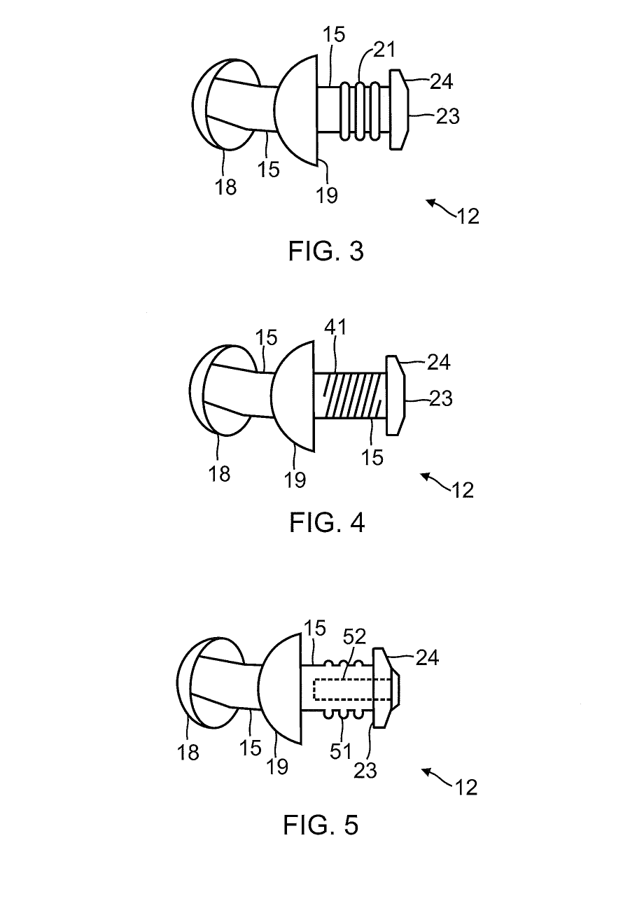

Referring now to FIG. 3, one or more rings 31 can be formed upon the stem 15 to define detents. The earpiece 11 can have similar rings formed in the opening 61 thereof. The earpiece 11 can have grooves that are complimentary to rings 31 formed in the opening thereof. The grooves can thus receive rings 31 so as to retain the stem 15 in a desired position with respect to the earpiece 11.

Referring now to FIG. 4, the stem 15 can have threads 41 formed thereon. The threads 41 can engage complimentary threads formed within opening 61 to facilitate adjustment of the length of stem 15 within a user's ear canal.

Referring now to FIG. 5, one or more bumps 51 can be formed upon the stem 15 to define detents. The earpiece 11 can have similar bumps formed in the opening 61 thereof. The earpiece 11 can have depressions that are complimentary to bumps 51 formed in the opening thereof. The depressions can thus receive bumps 51 so as to retain the stem 15 in a desired position with respect to the earpiece 11.

A filter 55 can be inserted into bore 22 to selectively mitigate sound exposure. For example, a Hoch's filter can be used to mitigate exposure to louder sounds, while still allowing a wearer to hear quieter sounds, such as speech.

Any desired combination of detents, e.g., rings, threads, and bumps, can be used on the stem and/or the earpiece to facilitate adjustment of the length of the stem 15 within a user's ear canal and/or to help maintain the position (such as the adjusted position) of the ear insert 12 with respect to the earpiece 11.

Referring now to FIGS. 6 and 7, an earpiece 11 that is configured for use in the left ear is shown with the ear insert removed therefrom Arcuate rib 13 and straight rib 14 define a D shape. When a mirror image arcuate rib and straight rib are configured for use in the right ear, a reverse (mirror image) D is similarly defined.

For a medium size earpiece, the height, Dimension G, can be approximately 1.087 inch and the width, Dimension H, can be approximately 0.802 inch. For a large size earpiece, the height, Dimension G, can be approximately 1.150 inch and the width, Dimension H, is approximately 0.850 inch. The medium size fits a large percentage of people.

The medium size earpiece can be configured to fit most adult ears. More particularly, the medium size earpiece can be configured to fit at least 70% of ears of men between 19 and 40 years old. Arcuate rib 13 tends to deform or bend so as to accommodate a wide range of ear sizes.

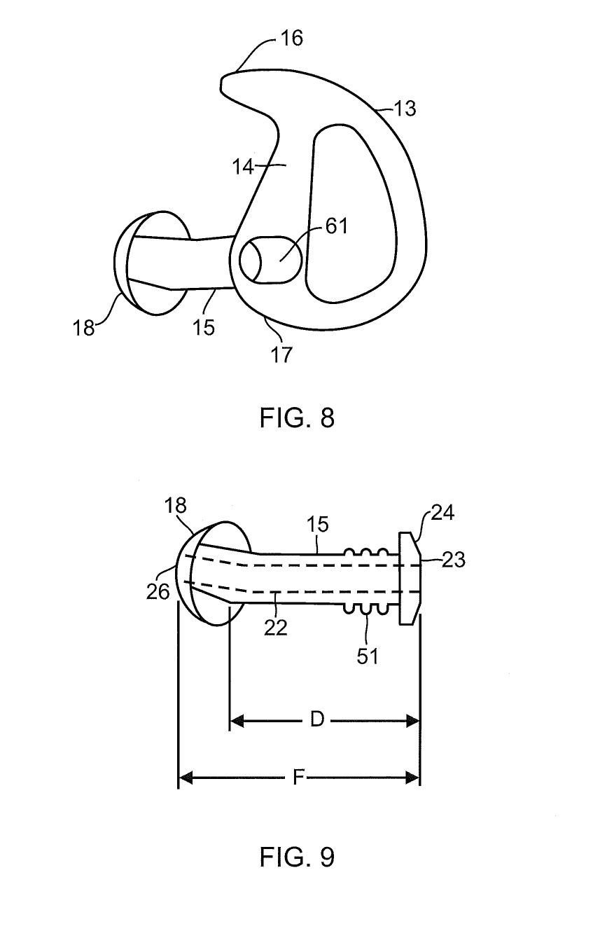

Referring now to FIGS. 8 and 9, outer flange 19 can optionally be omitted. Indeed, as mentioned above, ear insert 12 can comprise any desired number of flanges, including no flanges. In some instances, a single flange may perform adequately. This is particularly true when it is desirable to allow the wearer to hear ambient sound. Omitting the other flange(s) better allows ambient sound to be heard. In some applications, the primary reason for wearing the earpiece may be to allow the wearer to better hear radio communications. Positioning output port 26 close to the eardrum accomplishes this goal.

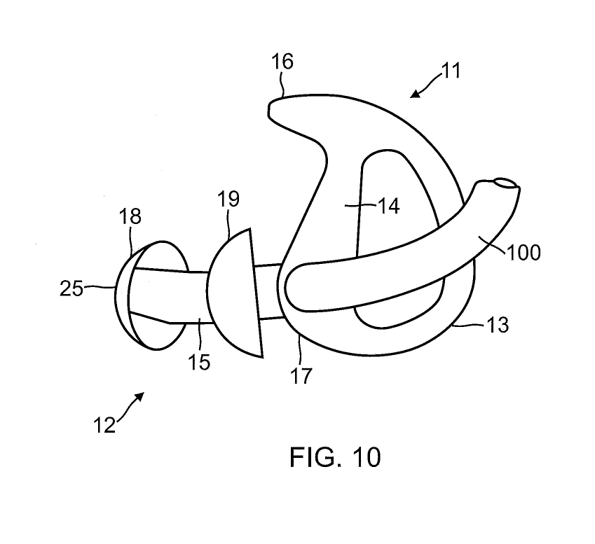

Referring now to FIG. 10, an acoustic tube 100 can be attached to earpiece 11 and/or ear insert 12 such that a generally continuous bore is defined for sound to travel though from a speaker to the eardrum. A barbed metal or plastic fitting can be used to accomplish such attachment. Other methods of attachment, such as the use of adhesive bonding and/or ultrasonic welding, are likewise suitable.

Since the distal end 25 of ear insert 12 can be placed close to a wearer's eardrum, the volume of a two-way radio or other device (such as a cellular telephone, CD player, MP3 player, etc.) can be substantially reduced. With the volume reduced, sound advantageously cannot be as easily heard by others. Thus, during covert operations, for example, the likelihood of someone other than the wearer undesirably hearing sound from a two-way radio is substantially mitigated. By reducing the sound volume, smaller, less powerful, and/or less expensive speakers can be used. Placing the sound closer to the eardrum can make it easier for the hearing impaired to hear.

Sound transmissive embodiments of the present invention (such as those embodiments having a bore 22 formed through stem 15) can similarly be used with a variety of personal electronic devices that produce sound, including two-way radios, cellular telephones, MP3 players, CD players, cassette players, personal digital assistants (PDAs), desktop computers, laptop computers, notebook computers, pocket PCs, and hearing aids.

According to one aspect, earpiece 11 is configured to fit multiple sizes of ears. More particularly, arcuate rib 13 is deformable so as to permit earpiece 11 to fit into smaller conchae bowls.

The opening 61 (FIG. 6) in earpiece 11 can be configured such that the flanged ear insert is positioned at the top of the ear canal, at the bottom of the ear canal, at one side of the ear canal, or is approximately centered in the ear canal. Configuring the opening such that the flanged ear insert is not approximately centered causes the flanged ear insert to be biased toward an inner surface of the ear canal and can help to keep the earpiece and ear insert in the ear.

However, as long as the earpiece and/or the flanges of the insert are sufficient to keep the earpiece and ear insert in the ear, then the flanged ear insert can be positioned approximately in the center of the ear canal. Positioning the flanged ear insert approximately in the center of the ear canal may be more comfortable for some wearers.

As discussed above, the stem of the ear insert can be substantially hollow, e.g., have a bore formed therethrough, so as to facilitate the transmission of sound. The stem of the earpiece can be substantially solid such that the earpiece assembly functions as an earplug and mitigates the transmission of ambient sound to the eardrum.

A user can wear one earpiece assembly having a substantially hollow, sound transmissive insert to facilitate listening to a two-way radio or the like. The user can also wear one earpiece having a substantially solid, sound-mitigating insert to mitigate ambient sound and to provide hearing protection. The sound transmissive insert can also block ambient sound so as to provide hearing protection.

Although described herein a being for use in human ears, one or more embodiments of the present invention can also be used in non-human ears. For example, the present invention can be configured for canine ears, so as to mitigate noise exposure and or facilitate communication with police or military dogs. As those skilled in the art will appreciate, such dogs are commonly exposed to noisy environments, such as those environments sometimes encountered in police work and on the battlefield. Further, it is frequently desirable to communicate with such dogs. Their ability to respond to radio commands has been established.

Thus, one or more embodiments of the present invention can mitigate noise exposure and/or facilitate communications. Noise exposure is mitigated by at least partially blocking the ear canal with an ear insert from an earpiece. Communications are facilitated by providing a passage for sound through the ear insert. The ear insert can be adjusted such that a distal end or sound port thereof extends to a point proximate the eardrum, so that sound is delivered more directly to the eardrum. Thus, less volume is needed. The use of less volume is useful in covert operations. As stated above, it may also facilitate the use of smaller, less powerful, and/or less expensive speakers.

Adjustment of the position of the distal end of the ear insert, as well as of the flanges formed upon the ear insert, facilitates enhanced fitting of the earpiece assembly. In this manner, comfort is enhanced. Because comfort is enhanced, a user is more likely to wear the earplugs. A better fit allows earpiece assemblies for both communications and hearing protection to be worn for longer periods of time. A better fit also substantially reduces the likelihood of tissue damage to the ear cause by the earpiece assembly.

Although both communications and hearing protection embodiments are disclosed, it is worthwhile to appreciate that both embodiments can possess attributes of one another and that the distinction between the embodiments is not always clear. For example, communication embodiments can have features and functions of hearing protection. Communication embodiments can substantially mitigate exposure to ambient sound. Features discussed herein in conjunction with one embodiment may be used in the other embodiment.

Embodiments described above illustrate, but do not limit, the invention. It should also be understood that numerous modifications and variations are possible in accordance with the principles of the present invention. Accordingly, the scope of the invention is defined only by the following claims.

1. An ear insert comprising:
a stem configured to extend into an ear canal; and
wherein the stem is configured to attached to an earpiece such that a length of the stem within an ear canal is variable.

2. The ear insert as recited in claim 1, wherein the stem is substantially solid so as to inhibit the transmission of ambient sound therethrough.

3. The ear insert as recited in claim 1, wherein the stem has a bore formed substantially therethrough so as to facilitate the transmission of sound therethrough.

4. The ear insert as recited in claim 1, wherein the stem is slidably attachable to the earpiece.

5. The ear insert as recited in claim 1, wherein the stem is slidably attachable to the earpiece and further comprising a plurality of detents formed upon the stem so as to tend to inhibit slipping of the stem with respect to the earpiece.

6. The ear insert as recited in claim 1, further comprising at least one flange formed upon the stem.

7. The ear insert as recited in claim 1, wherein the stem is threadedly attachable to the earpiece.

8. The ear insert as recited in claim 1, wherein the insert is formed of silicone rubber.

9. The ear insert as recited in claim 1, wherein the insert is formed of a resilient material having Shore A durometer of between approximately 35 and approximately 45.

10. The ear insert as recited in claim 1, wherein the insert is formed of a resilient material having Shore A durometer of approximately 40.

11. An earpiece assembly comprising:
an earpiece configured to fit substantially within the conchae of an ear;
an ear insert comprising:
a stem configured to extend into an ear canal; and
wherein the stem is attached to the earpiece such that a length of the stem within ear canal is variable.

12. The earpiece assembly as recited in claim 11, wherein the stem is substantially solid so as to inhibit the transmission of ambient sound therethrough.

13. The earpiece assembly as recited in claim 11, wherein the stem has a bore formed substantially therethrough so as to facilitate the transmission of sound therethrough.

14. The earpiece assembly as recited in claim 11, wherein the stem is slidably attached to the earpiece.

15. The earpiece assembly as recited in claim 11, wherein the stem is slidably attached to the earpiece and further comprising a plurality of detents formed upon the stem so as to tend to inhibit slipping of the stem with respect to the earpiece.

16. The earpiece assembly as recited in claim 11, further comprising at least one flange formed upon the stem.

17. The earpiece assembly as recited in claim 11, wherein the stem is threadedly attachable to the earpiece.

18. The earpiece assembly as recited in claim 11, wherein the insert is formed of silicone rubber.

19. The earpiece assembly as recited in claim 11, wherein the earpiece and the insert are formed of a resilient material having Shore A durometer of between approximately 35 and approximately 45.

20. The earpiece assembly as recited in claim 11, wherein the earpiece and the insert are formed of a resilient material having Shore A durometer of approximately 40.

21. An ear insert comprising:
a stem configured to extend into an ear canal; and
means for attaching the stem to an earpiece such that a length of the stem within the ear canal is adjustable.

22. An earpiece assembly comprising:
means for removably attaching the earpiece assembly to an ear;
an ear insert configured to extend into an ear canal, the ear insert comprising:
a stem attached to the means for removably attaching the earpiece assembly to an ear; and
means for adjusting a length of the stem that extends into the ear canal.

23. An earplug comprising:
a stem configured to extend into an ear canal;
at least one flange formed upon the stem; and
wherein the stem is configured to attached to an earpiece such that a position of the flange(s) within ear canal is variable.
